(19) United States
(12) Patent Application Publication
(10) Pub. No.: US 2024/0087073 A1
(43) Pub. Date: Mar. 14, 2024

(54) MANAGEMENT DEVICE AND MANAGEMENT METHOD

(71) Applicant: TOYOTA JIDOSHA KABUSHIKI KAISHA, Toyota-shi (JP)

(72) Inventors: Atsushi KOMADA, Nagakute-shi (JP); Mitsuru OGASAWARA, Gamagori-shi (JP); Masahiko ISHII, Okazaki-shi (JP); Hidetaka ASANO, Nissin-shi (JP); Tomokazu ISHII, Okazaki-shi (JP); Koji HETSUGI, Toyota-shi (JP); Kosuke YONEKAWA, Nisshin-shi (JP); Yoshikazu JIKUHARA, Miyoshi-shi (JP)

(73) Assignee: TOYOTA JIDOSHA KABUSHIKI KAISHA, Toyota-shi (JP)

(21) Appl. No.: 18/219,959

(22) Filed: Jul. 10, 2023

(30) Foreign Application Priority Data
Sep. 13, 2022 (JP) 2022-145301

(51) Int. Cl. G06Q 50/30; G06Q 50/06

(52) U.S. Cl. CPC G06Q 50/30; G06Q 50/06

(57) ABSTRACT

A control device reads power consumption, information on the delivery number and weight of a first product set, and information on the delivery number and weight of a second product set from a storage device. The control device proportionally divides the power consumption. The control device reads a first conversion formula from the storage device, and calculates CO2 emissions from transportation of the first product set from an A station to a B station and CO2 emissions from transportation of the second product set from the A station to the B station by substituting the power consumptions, into the first conversion formula.

### CROSS-REFERENCE TO RELATED APPLICATION

This application claims priority to Japanese Patent Application No. 2022-145301 filed on Sep. 13, 2022, incorporated herein by reference in its entirety.

### BACKGROUND

### 1. Technical Field

The present disclosure relates to management devices and management methods.

### 2. Description of Related Art

With growing awareness of environmental issues, there is growing interest in carbon dioxide (CO2) emissions from production of products distributed on the market. There are cases where a downstream company in a supply chain to which an upstream company in the supply chain delivers a product requests the upstream company to disclose CO2 emissions from production of the product. The upstream company calculates the CO2 emissions from the production of the product and discloses the calculated CO2 emissions to the downstream company.

For example, Japanese Unexamined Patent Application Publication No. 2016-126372 (JP 2016-126372 A) discloses a method for calculating CO2 emissions in a transportation process of products (including materials and components). The method for calculating the CO2 emissions in the transportation process disclosed in JP 2016-126372 A is a method for calculating CO2 emissions corresponding to the purchase amount of goods based on a predetermined factor table, the industry to which the company belongs, and the purchase amount of the goods.

### SUMMARY

It is desirable to consider not only CO2 emissions in a production process but also CO2 emissions in a transportation process when calculating CO2 emissions from production of a product. For example, there are cases where a plurality of products (components, raw materials) to be delivered to different destinations is consolidated on a moving object for transporting products, such as a train or a transport vehicle. It is desired to establish a method for accurately calculating CO2 emissions in the transportation process of each product to be delivered in such cases.

The present disclosure provides a management device and management method for accurately calculating CO2 emissions in a transportation process of each product when a plurality of products is consolidated on a moving object for transporting products.

(1) A management device according to one aspect of the present disclosure is a management device that manages a moving object that transports a plurality of products as a consolidated load. The products include a first product and a second product. The management device includes: a storage device that stores an amount of energy consumed by the moving object in a transport section; and a control device that calculates CO2 emissions of the first product from the transportation and CO2 emissions of the second product from the transportation, based on the amount of energy and a weight ratio between the first and second products loaded on the moving object.

According to the above configuration, the control device calculates the CO2 emissions of the first product from the transportation and the CO2 emissions of the second product from the transportation, based on the amount of energy consumed by the transportation in the transport section where the products are consolidated and the weight ratio between the consolidated products. The CO2 emissions of the first product from the transportation and the CO2 emissions of the second product from the transportation can be appropriately calculated by using the weight ratio between the consolidated products.

(2) In one embodiment, the control device may proportionally divide the amount of energy between the first product and the second product based on the weight ratio to calculate the CO2 emissions of the first product from the transportation and the CO2 emissions of the second product from the transportation.

According to the above configuration, the control device proportionally divides the amount of energy consumed by the transportation in the transport section where the products are consolidated, based on the weight ratio between the consolidated products. The CO2 emissions of the first product from the transportation and the CO2 emissions of the second product from the transportation can be appropriately calculated by proportionally dividing the amount of energy based on the weight ratio.

(3) In one embodiment, the transport section may include a first section where the first product and the second product are consolidated, and a second section where the first product is loaded and the second product is not loaded. The control device may proportionally divide an amount of energy consumed by the moving object in the first section between the first product and the second product based on the weight ratio between the first and second products, and may proportionally divide an amount of energy consumed by the moving object in the second section to the first product.

According to the above configuration, the control device proportionally divides, for each section, the amount of energy consumed in the section based on the weight ratio between the consolidated products. Since the first product and the second product are consolidated in the first section, the control device proportionally divides (allots) the amount of energy consumed by the moving object in the first section between the first product and the second product based on the weight ratio. On the other hand, since the second product is not loaded in the second section, the control device proportionally divides (allots) the amount of energy consumed by the moving object in the second section to the first product. By thus proportionally dividing, for each section divided based on whether the products are consolidated, the amount of energy consumed in the section, the CO2 emissions of the first product from the transportation and the CO2 emissions of the second product from the transportation can be appropriately calculated.

(4) In one embodiment, the storage device may store conversion information for converting an amount of energy to CO2 emissions. The control device may use the conversion information to convert the amount of energy proportionally divided to the first product to the CO2 emissions of the first product from the transportation and convert the amount of energy proportionally divided to the second product to the CO2 emissions of the second product from the transportation.

According to the above configuration, power consumption can be appropriately converted to CO2 emissions.

(5) A management method according to another aspect of the present disclosure is a management method for managing a moving object that transports a plurality of products as a consolidated load. The products include a first product and a second product. The management method includes: reading an amount of energy consumed by the moving object in a transport section; and calculating CO2 emissions of the first product from the transportation and CO2 emissions of the second product from the transportation, based on the amount of energy and a weight ratio between the first and second products loaded on the moving object.

According to the present disclosure, in the case where a plurality of products is consolidated on a moving object for transporting products, CO2 emissions in a transportation process of each product can be accurately calculated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows the overall configuration of a management system 100 according to a first embodiment;

FIG. 2 shows the hardware configuration of the management system 100 according to the first embodiment;

FIG. 3 is a functional block diagram of a control device 51 showing a function to calculate CO2 emissions from transportation by a transport train 5;

FIG. 4 is a flowchart of a process that is performed by the control device 51 to calculate the CO2 emissions from the transportation by the transport train 5;

FIG. 5 shows the overall configuration of a management system 100A according to a second embodiment; and

FIG. 6 is a flowchart of a process that is performed by the control device 51 to calculate the CO2 emissions from the transportation by the transport train 5.

### DETAILED DESCRIPTION OF EMBODIMENTS

Hereinafter, embodiments of the present disclosure will be described in detail with reference to the drawings. The same or corresponding portions are denoted by the same signs throughout the drawings, and description thereof will not be repeated.

### First Embodiment

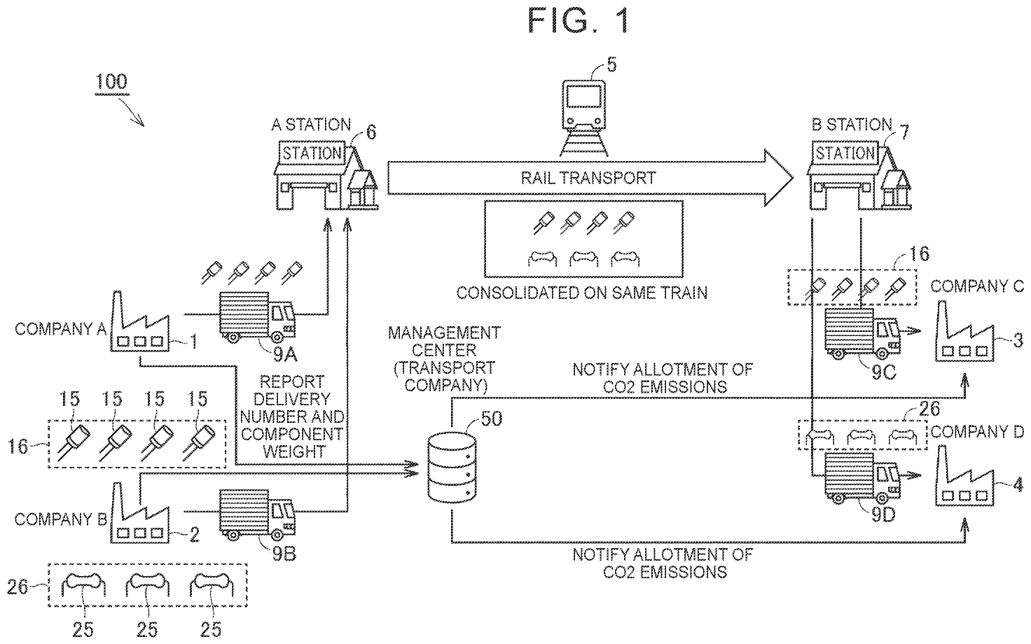

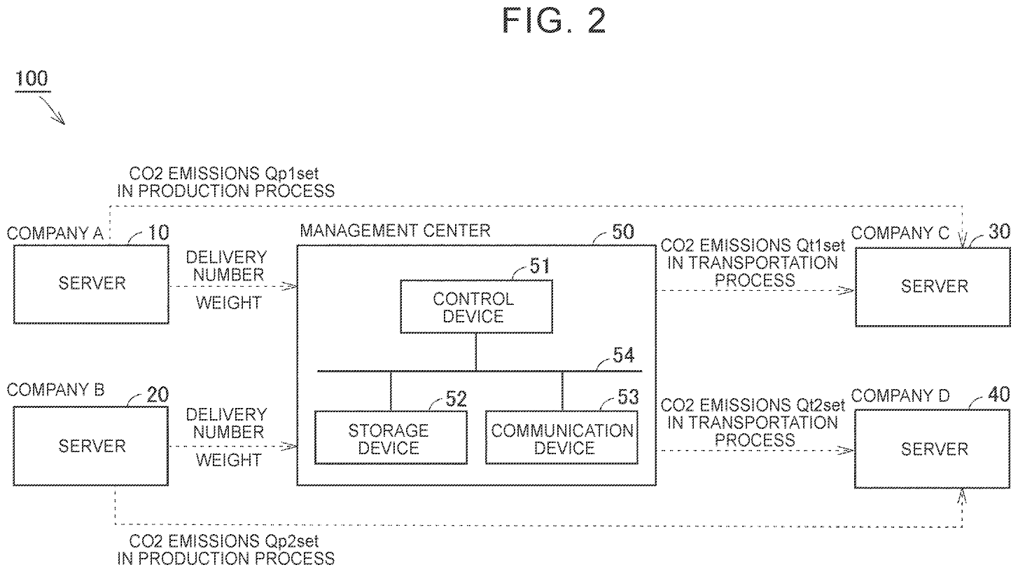

FIG. 1 shows the overall configuration of a management system 100 according to a first embodiment. FIG. 2 shows the hardware configuration of the management system 100 according to the first embodiment. The management system 100 is a system for managing CO2 emissions from production of products.

Referring to FIGS. 1 and 2, the management system 100 includes a server 10 belonging to a company A, a server 20 belonging to a company B, a server 30 belonging to a company C, a server 40 belonging to a company D, and a management center 50 that manages transport vehicles 9A to 9D and a transport train 5.

In the first embodiment, at least the company A and the company C form a supply chain. The company A is a company upstream of the company C in the supply chain. The company A produces products 15 in a factory 1. The products 15 are electronic components. The products 15 are not limited to the electronic components, and may be various raw materials. The products 15 produced in the factory 1 are grouped into, for example, predetermined delivery units to form product sets 16. The product set 16 is delivered to a factory 3 of the company C via, for example, a plurality of means of transportation.

In the first embodiment, at least the company B and the company D form a supply chain. The company B is a company upstream of the company D in the supply chain. The company B produces products 25 in a factory 2. The products 25 are electronic components. The products 25 are not limited to the electronic components, and may be various raw materials. The products 25 produced in the factory 2 are grouped into, for example, predetermined delivery units to form product sets 26. The product set 26 is delivered to a factory 4 of the company D via, for example, a plurality of means of transportation.

The server 10 of the company A stores CO2 emissions Qp1 per unit number of products 15. The CO2 emissions Qp1 includes CO2 emissions required to produce the unit number of products 15 using a raw material on a production line of the company A, and CO2 emissions from production of the raw material. CO2 emissions from production of the raw material can be acquired from an upstream company (not shown) in the supply chain. The server 10 also calculates CO2 emissions Qp1set per product set 16 using the CO2 emissions Qp1, and stores the calculated CO2 emissions Qp1set. The CO2 emissions Qp1set is hereinafter also referred to as “CO2 emissions Qp1set in the production process.”

The server 10 sends the CO2 emissions Qp1set in the production process to the server 30 of the company C in response to a request from the server 30 or when the product set 16 has been delivered to the company C.

The server 20 of the company B stores CO2 emissions Qp2 per unit number of products 25. The CO2 emissions Qp2 includes CO2 emissions required to produce the unit number of products 25 using a raw material on a production line of the company B, and CO2 emissions from production of the raw material. CO2 emissions from production of the raw material can be acquired from an upstream company (not shown) in the supply chain. The server 20 also calculates CO2 emissions Qp2set per product set 26 using the CO2 emissions Qp2, and stores the calculated CO2 emissions Qp2set. The CO2 emissions Qp2set is hereinafter also referred to as “CO2 emissions Qp2set in the production process.”

The server 20 sends the CO2 emissions Qp2set in the production process to the server 40 of the company D in response to a request from the server 40 or when the product set 26 has been delivered to the company D.

The management center 50 manages the transport vehicles 9A to 9D and the transport train 5. For example, a company that operates the management center 50 receives requests for transportation of products from the company A and the company B. The present embodiment illustrates an example in which the management center 50 manages both the transport vehicles 9A to 9D and the transport train 5. However, a management entity that manages the transport vehicles 9A to 9D and a management entity that manages the transport train 5 may be different. In such a case, a management center that manages the transport vehicles 9A to 9D and a management center that manages the transport train 5 are provided. The transport vehicles 9A to 9D are hereinafter sometimes collectively referred to as “transport vehicles 9” when they are not particularly distinguished from each other.

The product set 16 is first loaded onto the transport vehicle 9A at the factory 1 of the company A and transported to an A station 6. The product set 16 is then loaded onto the transport train 5 at the A station 6 and transported to a B station 7. The product set 16 is subsequently loaded onto the transport vehicle 9C at the B station 7 and transported to the factory 3 of the company C. The product set 26 is first loaded onto the transport vehicle 9B at the factory 2 of the company B and transported to the A station 6. The product set 26 is then loaded onto the transport train 5 at the A station 6 and transported to the B station 7. The product set 26 is subsequently loaded onto the transport vehicle 9D at the B station 7 and transported to the factory 4 of the company D. In this example, the shipments of the product set 16 and the product set 26 are consolidated onto the transport train 5 and transported from the A station 6 to the B station 7.

The transport vehicles 9 are vehicle with an internal combustion engine (not shown). The transport vehicles 9 are equipped with a communication device and a Global Positioning System (GPS) receiver, both of which are not shown. The communication device may be, for example, a Data Communication Module (DCM). The transport vehicles 9 are configured to communicate with the management center 50 via the communication device. The transport vehicles 9 are configured to send location information and fuel consumption information to the management center 50 at predetermined intervals. The fuel consumption information indicates the amount of fuel consumed by the transport vehicle 9 during the predetermined interval. The fuel consumption information may be information on the remaining amount of fuel.

The transport train 5 is driven with electricity or fuel. The transport train 5 may be an electric train or a diesel train. In the first embodiment, the transport train 5 is an electric train that is driven with electricity. The transport train 5 includes a power converter, a motor, and a communication device, none of which are shown. The transport train 5 is configured to send power consumption (energy consumption) information to the management center 50 at predetermined intervals.

The management center 50 includes a control device 51, a storage device 52, and a communication device 53. The control device 51, the storage device 52, and the communication device 53 are connected to a bus 54. The management center 50 is an example of the “management device” according to the present disclosure.

The control device 51 is configured by, for example, an integrated circuit including a central processing unit (CPU). The control device 51 includes a memory and executes various programs stored in the memory. The various programs include an operating system. The memory includes, for example, a read-only memory (ROM) storing the various programs, and a random access memory (RAM) that functions as a working memory and temporarily stores various types of data necessary to execute the various programs.

The storage device 52 stores a first conversion formula (first conversion information) for converting power consumption to CO2 emissions, and a second conversion formula (second conversion information) for converting fuel consumption to CO2 emissions. The first conversion formula may be, for example, a formula of multiplying power consumption by a first CO2 emissions factor. The first CO2 emissions factor may be, for example, a value published by a country, a government, or a business operator. The first CO2 emissions factor may be set for each type of power (whether the power is renewable energy, etc.). The second conversion formula may be, for example, a formula of multiplying fuel consumption by a second CO2 emissions factor. The second CO2 emissions factor may be, for example, a value published by a country, a government, or a business operator. The second CO2 emissions factor may be set for, for example, each type of fuel (gasoline, light oil, biodiesel, etc.). The first conversion formula and the second conversion formula are updated by the control device 51 when, for example, the published first CO2 emissions factor and the published second CO2 emissions factor are updated.

The communication device 53 is configured to communicate with each of the servers 10 to 40. Communication between the communication device 53 and each of the servers 10 to 40 is performed via, for example, the Internet. The communication device 53 is configured to communicate with the transport train 5 and the transport vehicles 9. Communication between the communication device 53 and the transport train 5 and transport vehicles 9 is performed via, for example, the Internet.

The control device 51 calculates CO2 emissions in the transportation process, and reports the calculated CO2 emissions to destination companies (in the first embodiment, the company C and the company D).

In the first embodiment, the management center 50 receives a request for transportation of the product set 16 from the server 10 of the company A. The server 10 notifies the management center 50 of information on the delivery number and weight of the product set 16. The management center 50 also receives a request for transportation of the product set 26 from the server 20 of the company B. The server 20 notifies the management center 50 of information on the delivery number and weight of the product set 26.

The transport vehicle 9A and the transport vehicle 9B receive the product set 16 and the product set 26 at the factory 1 of the company A and the factory 2 of the company B, respectively. The transport vehicle 9A transports the product set 16 from the factory 1 of the company A to the A station 6. The transport vehicle 9B transports the product set 26 from the factory 2 of the company B to the A station 6. The shipments of the product set 16 and the product set 26 are consolidated onto the transport train 5 and transported from the A station 6 to the B station 7. Subsequently, the product set 16 is loaded onto the transport vehicle 9C at the B station 7 and delivered to the factory 3 of the company C. The product set 26 is loaded onto the transport vehicle 9D at the B station 7 and delivered to the factory 4 of the company D.

In the first embodiment, it is assumed that only the product set 16 is loaded onto the transport vehicles 9A, 9C. It is also assumed that only the product set 26 is loaded onto the transport vehicles 9B, 9D. It is also assumed that only the product sets 16, 26 are loaded onto the transport train 5.

The control device 51 calculates CO2 emissions Qa from the transportation of the product set 16 from the factory 1 of the company A to the A station 6, based on fuel consumption Fa of the transport vehicle 9A from this transportation. The control device 51 calculates the CO2 emissions Qa by substituting the fuel consumption Fa into the second conversion formula. The control device 51 also calculates CO2 emissions Qm1 from the transportation of the product set 16 from the A station 6 to the B station 7 by the transport train 5 by a method described later. The control device 51 also calculates CO2 emissions Qc from the transportation of the product set 16 from the B station 7 to the factory 3 of the company C, based on fuel consumption Fc of the transport vehicle 9C from this transportation.

The control device 51 calculates CO2 emissions Qt1set in the transportation process of the product set 16 by adding the CO2 emissions Qa, the CO2 emissions Qm1, and the CO2 emissions Qc according to the following expression (1).

Qt1set=Qa+Qm1+Qc (1)

The control device 51 reports the calculated CO2 emissions Qt1set in the transportation process to the server 30 of the company C via the communication device 53.

The server 30 of the company C calculates CO2 emissions Q1 set of the delivered product set 16 by adding the CO2 emissions Qp1set in the production process reported from the company A and the CO2 emissions Qt1set in the transportation process reported from the management center 50. For example, the server 30 can calculate CO2 emissions Q1 of the product 15 by dividing the CO2 emissions Q1set by the number of products 15 in the product set 16. The server 30 of the company C stores the CO2 emissions Q1set and the CO2 emissions Q1.

The control device 51 calculates CO2 emissions Qb from the transportation of the product set 26 from the factory 2 of the company B to the A station 6, based on fuel consumption Fb of the transport vehicle 9B from this transportation. The control device 51 calculates the CO2 emissions Qb by substituting the fuel consumption Fb into the second conversion formula. The control device 51 also calculates CO2 emissions Qm2 from the transportation of the product set 26 from the A station 6 to the B station 7 by the transport train 5 by a method described later. The control device 51 also calculates CO2 emissions Qd from the transportation of the product set 26 from the B station 7 to the factory 4 of the company D, based on fuel consumption Fd of the transport vehicle 9D from this transportation.

The control device 51 calculates CO2 emissions Qt2set in the transportation process of the product set 26 by adding the CO2 emissions Qb, the CO2 emissions Qm2, and the CO2 emissions Qd according to the following expression (2).

Qt2set=Qb+Qm2+Qd (2)

The control device 51 reports the calculated CO2 emissions Qt2set in the transportation process to the server 40 of the company D via the communication device 53.

The server 40 of the company D calculates CO2 emissions Q2set of the delivered product set 26 by adding the CO2 emissions Qp2set in the production process reported from the company B and the CO2 emissions Qt2set in the transportation process reported from the management center 50. For example, the server 40 can calculate CO2 emissions Q2 of the product 25 by dividing the CO2 emissions Q2set by the number of products 25 in the product set 26. The server 40 of the company D stores the CO2 emissions Q2set and the CO2 emissions Q2.

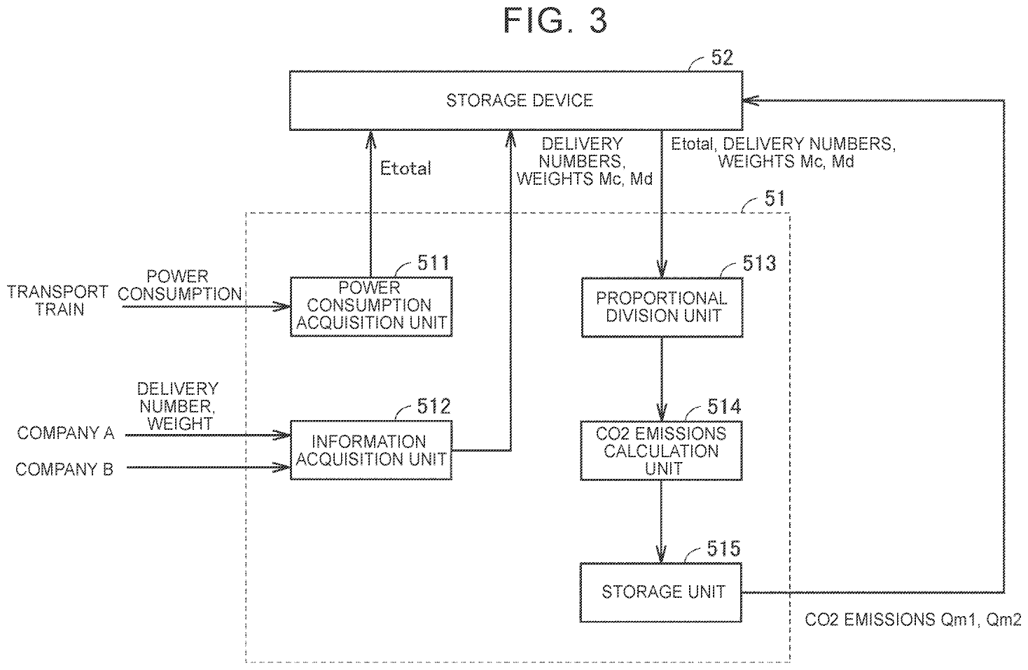

FIG. 3 is a functional block diagram of the control device 51 showing the function to calculate the CO2 emissions from the transportation by the transport train 5. The control device 51 includes a power consumption acquisition unit 511, an information acquisition unit 512, a proportional division unit 513, a CO2 emissions calculation unit 514, and a storage unit 515. The control device 51 functions as the power consumption acquisition unit 511, the information acquisition unit 512, the proportional division unit 513, the CO2 emissions calculation unit 514, and the storage unit 515 by executing the programs stored in the memory. The power consumption acquisition unit 511, the information acquisition unit 512, the proportional division unit 513, the CO2 emissions calculation unit 514, and the storage unit 515 may be implemented by, for example, dedicated hardware (electrical circuitry).

The power consumption acquisition unit 511 acquires the power consumption information from the transport train 5 via the communication device 53. The power consumption acquisition unit 511 accumulates the power consumption acquired while the transport train 5 moves from the A station 6 to the B station 7. The power consumption acquisition unit 511 stores the accumulated power consumption Etotal in the storage device 52. The power consumption acquisition unit 511 may be configured to output the power consumption Etotal to the proportional division unit 513.

The information acquisition unit 512 acquires information on the delivery number and weight Mc of the product set 16 from the server 10 of the company A. The information acquisition unit 512 stores the information on the delivery number and weight Mc in the storage device 52. The information acquisition unit 512 also acquires information on the delivery number and weight Md of the product set 26 from the server 20 of the company B. The information acquisition unit 512 stores the information on the delivery number and weight Md in the storage device 52.

The proportional division unit 513 reads from the storage device 52 the power consumption Etotal, the information on the delivery number and weight Mc, and the information on the delivery number and weight Md. The proportional division unit 513 proportionally divides the power consumption Etotal based on the weight ratio between the product set 16 and the product set 26. The proportional division unit 513 calculates power consumption E1 allotted to the product set 16 according to the following expression (3). The proportional division unit 513 also calculates power consumption E2 allotted to the product set 26 according to the following expression (4).

E1=Etotal×Mc/(Mc+Md) (3)

E2=Etotal×Md/(Mc+Md) (4)

The proportional division unit 513 associates each of the calculated power consumption E1 and power consumption E2 with a corresponding one of the delivery numbers, and outputs the power consumption E1 and power consumption E2 in association with the delivery numbers to the CO2 emissions calculation unit 514.

The CO2 emissions calculation unit 514 reads the first conversion formula from the storage device 52. The CO2 emissions calculation unit 514 calculates the CO2 emissions Qm1 from the transportation of the product set 16 from the A station 6 to the B station 7 by substituting the power consumption E1 into the first conversion formula. The CO2 emissions calculation unit 514 also calculates the CO2 emissions Qm2 from the transportation of the product set 26 from the A station 6 to the B station 7 by substituting the power consumption E2 into the first conversion formula. The CO2 emissions calculation unit 514 outputs the CO2 emissions Qm1, Qm2 to the storage unit 515.

The storage unit 515 associates each of the CO2 emissions Qm1, Qm2 with a corresponding one of the delivery numbers, and stores the CO2 emissions Qm1, Qm2 in association with the delivery numbers in the storage device 52.

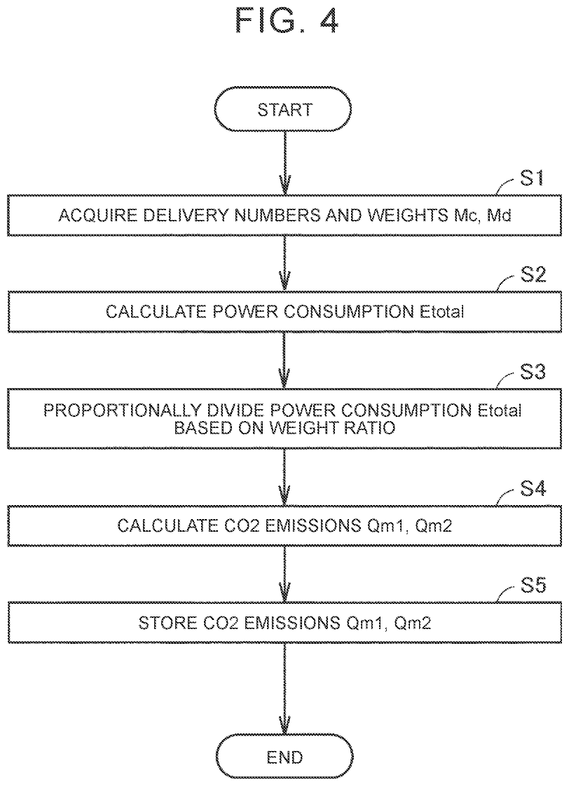

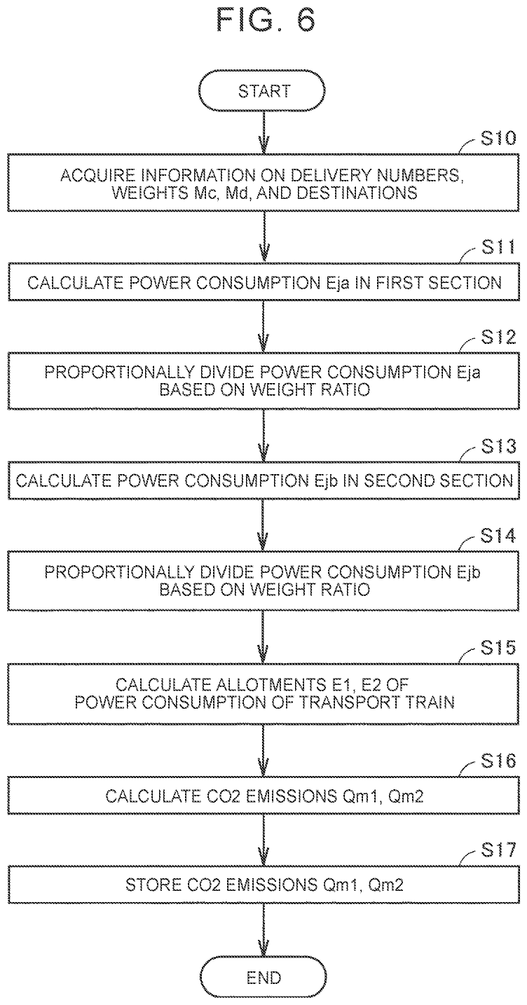

FIG. 4 is a flowchart of a process that is performed by the control device 51 to calculate CO2 emissions from transportation by the transport train 5. For example, this flowchart is started when completion of deliveries to the company C and the company D is detected. For example, completion of deliveries to the company C and the company D may be determined based on location information of the transport vehicles 9C, 9D, namely, based on the fact that the transport vehicles 9C, 9D have arrived at the premises of the company C and the premises of the company D, respectively. Alternatively, the control device 51 may determine completion of deliveries to Companies C and D based on receipt of delivery completion notifications from those terminal devices for deliverers that are associated with the transport vehicles 9C, 9D, respectively. Although an example in which each step (hereinafter the term “step” is abbreviated as “S”) in the flowcharts shown in FIG. 4 and FIG. 6 described later is implemented by software processing by the control device 51 is described herein, part or all of the steps may be implemented by hardware (electrical circuitry) fabricated in the control device 51.

In S1, the control device 51 acquires information on the delivery number and weight Mc of the product set 16 from the server 10 of the company A via the communication device 53. The control device 51 also acquires information on the delivery number and weight Md of the product set 26 from the server 20 of the company B via the communication device 53. The control device 51 stores the information on the delivery number and weight Mc of the product set 16 and the information on the delivery number and weight Md of the product set 26 in the storage device 52.

In S2, the control device 51 acquires power consumption information from the transport train 5 via the communication device 53, and accumulates the power consumption acquired while the transport train 5 moves from the A station 6 to the B station 7. The control device 51 calculates the accumulated power consumption as power consumption Etotal. For example, the control device 51 stores the power consumption Etotal in the storage device 52.

In S3, the control device 51 reads from the storage device 52 the power consumption Etotal, the information on the delivery number and weight Mc of the product set 16, and the information on the delivery number and weight Md of the product set 26. The control device 51 proportionally divides the power consumption Etotal based on the weight ratio between the product set 16 and the product set 26. Specifically, the control device 51 calculates the power consumption E1 allotted to the product set 16 and the power consumption E2 allotted to the product set 26 according to the above expressions (3), (4).

In S4, the control device 51 reads the first conversion formula from the storage device 52, and calculates the CO2 emissions Qm1 from the transportation of the product set 16 from the A station 6 to the B station 7 by substituting the power consumption E1 into the first conversion formula. The control device 51 also calculates the CO2 emissions Qm2 from the transportation of the product set 26 from the A station 6 to the B station 7 by substituting the power consumption E2 into the first conversion formula.

In S5, the control device 51 associates each of the CO2 emissions Qm1, Qm2 with a corresponding one of the delivery numbers, and stores the CO2 emissions Qm1, Qm2 in association with the delivery numbers in the storage device 52. More specifically, the control device 51 stores the CO2 emissions Qm1 in association with the delivery number of the product set 16 in the storage device 52. The control device 51 also stores the CO2 emissions Qm2 in association with the delivery number of the product set 26 in the storage device 52.

As described above, when calculating the CO2 emissions in the transportation process, the management center 50 according to the first embodiment performs the following calculation for a transport section where products are consolidated (in the first embodiment, the section from the A station 6 to the B station 7). The management center 50 proportionally divides the amount of energy consumed by the transportation in this transport section (in the first embodiment, the power consumption of the transport train 5), based on the weight ratio between the consolidated products. By proportionally dividing this amount of energy based on the weight ratio, the CO2 emissions in the transportation process for each product can be appropriately calculated.

For example, in the case where there is a transport section where products are consolidated on the transport vehicle 9, the fuel consumption F in this transport section can be proportionally divided based on the weight ratio between the consolidated products.

### First Modification

In the first embodiment, the amount of energy consumed in a transport section where products are consolidated is proportionally divided based on the weight ratio between the consolidated products, and each of the resultant amounts of energy is converted to CO2 emissions using a conversion formula. However, conversion of the amount of energy to CO2 emissions and proportional division may be performed in any order. For example, the amount of energy consumed in a transport section where products are consolidated may first be converted to CO2 emissions, and the resultant CO2 emissions may then be proportionally divided between the product set 16 and the product set 26 based on the weight ratio between the consolidated products. The first modification may be combined with second and third modifications and a second embodiment that will be described below.

### Second Modification

The first embodiment illustrates an example in which the transport vehicles 9 are vehicles with an internal combustion engine. However, the transport vehicles 9 are not limited to the vehicles with an internal combustion engine. For example, the transport vehicles 9 may be battery electric vehicles. In this case, the transport vehicles 9 include a battery and a drive device that is driven using the power of the battery. In the case where the transport vehicle 9 is a battery electric vehicle, CO2 emissions from the transportation by the transport vehicle 9 can be calculated using power consumption instead of fuel consumption.

In the first embodiment, the transport train and the transport vehicles are described as examples of the moving object. However, the moving object is not limited to the transport train and the transport vehicles. The moving object may be, for example, a two-wheeled vehicle, an aircraft, or a helicopter.

### Third Modification

It is also conceivable to share information between or among companies using distributed ledger technology in the management system 100. In this case, the servers 10 to 40 and the management center 50 function as nodes, and each node sends to a distributed ledger network transaction data including various types of information to be notified and reported. For example, a distributed ledger platform may be used that can limit sharing of transaction data between or among parties concerned. Sending and receiving information using the distributed ledger technology can make the information more tamper-resistant.

### Second Embodiment

The first embodiment and the first to third modifications illustrate an example in which the product set 16 and the product set 26 are loaded onto the transport train 5 at the same station and transported to the same station. However, the product set 16 and the product set 26 may be loaded onto the transport train 5 at different stations, and may be unloaded from the transport train 5 at different stations. The second embodiment illustrates an example in which the product set 16 and the product set 26 are unloaded from the transport train 5 at different stations.

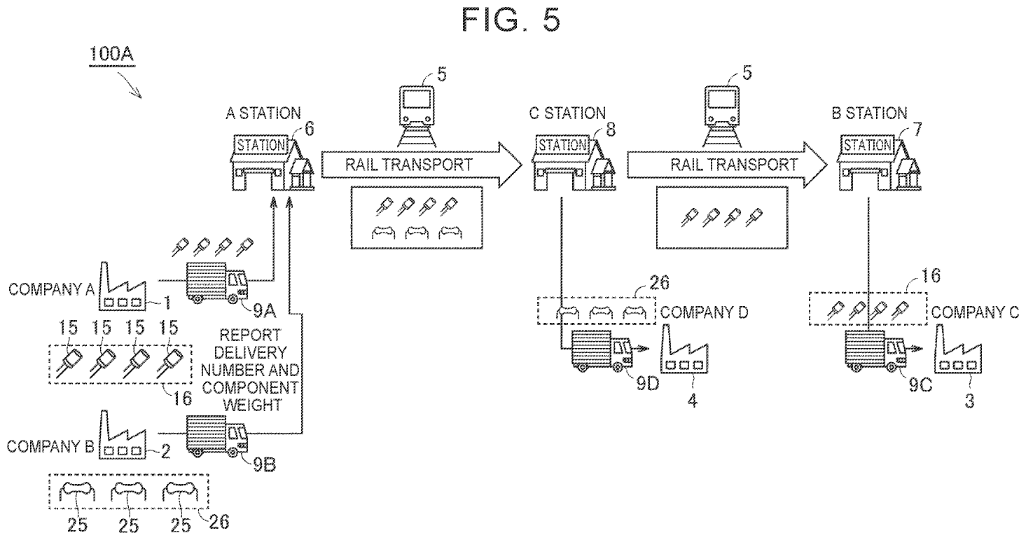

FIG. 5 shows the overall configuration of a management system 100A according to the second embodiment. The hardware configuration diagram of the management system 100A is the same as in FIG. 2.

Referring to FIG. 5, as in the first embodiment, the management center 50 receives a request for transportation of the product set 16 from the server 10 of the company A. The server 10 notifies the management center 50 of information on the delivery number and weight of the product set 16. The management center 50 also receives a request for transportation of the product set 26 from the server 20 of the company B. The server 20 notifies the management center 50 of information on the delivery number and weight of the product set 26.

The transport vehicle 9A and the transport vehicle 9B receive the product set 16 and the product set 26 at the factory 1 of the company A and the factory 2 of the company B, respectively. The transport vehicle 9A transports the product set 16 from the factory 1 of the company A to the A station 6. The transport vehicle 9B transports the product set 26 from the factory 2 of the company B to the A station 6. The product set 16 and the product set 26 are consolidated onto the transport train 5 and transported from the A station 6. In the second embodiment, the product set 26 is unloaded at a C station 8 located between the A station 6 and the B station 7. The product set 26 is loaded onto the transport vehicle 9D at the C station 8 and delivered to the factory 4 of the company D. The product set 16 is transported from the C station 8 to the B station 7. The product set 16 is loaded onto the transport vehicle 9C at the B station 7 and delivered to the factory 3 of the company C.

That is, the product set 16 and the product set 26 are consolidated on the transport train 5 in the transport section from the A station 6 to the C station 8, and only the product set 16 is loaded on the transport train 5 in the transport section from the C station 8 to the B station 7. Hereinafter, the transport section where products are consolidated, that is, the transport section from the A station 6 to the C station 8, is also referred to as “first section,” and the transport section where products are not consolidated, that is, the transport section from the C station 8 to the B station 7, is also referred to as “second section.”

The control device 51 of the management center 50 accumulates power consumption information acquired from the transport train 5 to calculate power consumption Eja accumulated while the transport train 5 moves from the A station 6 to the C station 8 (hereinafter also referred to as “power consumption Eja in the first section”). The control device 51 also calculates power consumption Ejb accumulated while the transport train 5 moves from the C station 8 to the B station 7 (hereinafter also referred to as “power consumption Ejb in the second section).

The control device 51 proportionally divides the power consumption Eja in the first section based on the weight ratio between the product set 16 and the product set 26. The control device 51 calculates power consumption Eja1 in the first section allotted to the product set 16 according to the following expression (5). The control device 51 also calculates power consumption Eja2 in the first section allotted to the product set 26 according to the following expression (6).

Eja1=Eja×Mc/(Mc+Md) (5)

Eja2=Eja×Md/(Mc+Md) (6)

The control device 51 then proportionally divides the power consumption Ejb in the second section based on the weight ratio between the product set 16 and the product set 26. The control device 51 calculates power consumption Ejb1 in the second section allotted to the product set 16 according to the following expression (7). The control device 51 also calculates power consumption Ejb2 in the second section allotted to the product set 26 according to the following expression (8).

Ejb1=Ejb×Mc/(Mc+Md) (7)

Ejb2=Ejb×Md/(Mc+Md) (8)

Since the product set 26 is not loaded on the transport train 5 in the second section, Md is zero.

The control device 51 calculates the power consumption E1, namely an allotment of the power consumption of the transport train 5 in the transport section (first section and second section) to the product set 16, according to the following expression (9). The control device 51 also calculates the power consumption E2, namely an allotment of the power consumption of the transport train 5 in the transport section to the product set 26, according to the following expression (10).

E1=Eja1+Ejb1 (9)

E2=Eja2+Ejb2 (10)

The control device 51 reads the first conversion formula from the storage device 52, and calculates the CO2 emissions Qm1 from the transportation of the product set 16 by the transport train 5 by substituting the power consumption E1 into the first conversion formula. The control device 51 also calculates the CO2 emissions Qm2 from the transportation of the product set 26 by the transport train 5 by substituting the power consumption E2 into the first conversion formula.

The control device 51 associates each of the CO2 emissions Qm1, Qm2 with a corresponding one of the delivery numbers, and stores the CO2 emissions Qm1, Qm2 in association with the delivery numbers in the storage device 52. The control device 51 calculates the CO2 emissions Qt1set in the transportation process of the product set 16 and the CO2 emissions Qt2set in the transportation process of the product set 26 according to the above expressions (1), (2) using the CO2 emissions Qm1, Qm2 stored in the storage device 52.

The CO2 emissions Qa from the transportation of the product set 16 from the factory 1 of the company A to the A station 6, the CO2 emissions Qb from the transportation of the product set 26 from the factory 2 of the company B to the A station 6, the CO2 emissions Qc from the transportation of the product set 16 from the B station 7 to the factory 3 of the company C, and the CO2 emissions Qd from the transportation of the product set 26 from the C station 8 to the factory 4 of the company D can be calculated using the fuel consumptions Fa to Fd and the second conversion formula, as described in the first embodiment.

FIG. 6 is a flowchart of a process that is performed by the control device 51 to calculate CO2 emissions from transportation by the transport train 5. For example, this flowchart is started when completion of deliveries to the company C and the company D is detected.

In S10, the control device 51 acquires information on the delivery number and weight Mc of the product set 16 from the server 10 of the company A via the communication device 53. The control device 51 also acquires information on a destination of the product set 16 from the server 10 of the company A via the communication device 53. The control device 51 also acquires information on the delivery number and weight Md of the product set 26 from the server 20 of the company B via the communication device 53. The control device 51 also acquires information on a destination of the product set 26 from the server 20 of the company B via the communication device 53. The control device 51 stores in the storage device 52 the information on the delivery number and weight Mc of the product set 16, the information on the destination of the product set 16, the information on the delivery number and weight Md of the product set 26, and the information on the destination of the product set 26.

The control device 51 can determine at which station to unload the product sets 16, 26 from the transport train 5 based on the information on the destination of the product set 16 and the information on the destination of the product set 26. In this example, the station to unload the product set 16 from the transport train 5 is determined to be the B station 7, and the station to unload the product set 26 from the transport train 5 is determined to be the C station 8. The control device 51 can thus recognize that the product sets 16, 26 are consolidated on the transport train 5 in the section from the A station 6 to the C station 8 (first section), and that only the product set 16 is loaded on the transport train 5 in the section from the C station 8 to the B station 7 (second station).

In S11, the control device 51 acquires power consumption information from the transport train 5 via the communication device 53, and calculates the power consumption of the transport train 5 accumulated while the transport train 5 moves from the A station 6 to the C station 8 (in the first section). That is, the control device 51 calculates the power consumption Eja in the first section. The control device 51 stores the power consumption Eja in the first section in the storage device 52.

In S12, the control device 51 proportionally divides the power consumption Eja in the first section based on the weight ratio between the product set 16 and the product set 26. Specifically, the control device 51 calculates the power consumption Eja1 in the first section allotted to the product set 16 and the power consumption Eja2 in the first section allotted to the product set 26 according to the above expressions (5), (6).

In S13, the control device 51 acquires power consumption information from the transport train 5 via the communication device 53, and calculates the power consumption of the transport train 5 accumulated while the transport train 5 moves from the C station 8 to the B station 7 (in the second section). That is, the control device 51 calculates the power consumption Ejb in the second section.

In S14, the control device 51 proportionally divides the power consumption Ejb in the second section based on the weight ratio between the product set 16 and the product set 26. Specifically, the control device 51 calculates the power consumption Ejb1 in the second section allotted to the product set 16 and the power consumption Ejb2 in the second section allotted to the product set 26 according to the above expressions (7), (8). In this case, the control device 51 sets the weight Md to zero.

In S15, the control device 51 calculates the power consumption E1 that is an allotment of the power consumption of the transport train 5 to the product set 16 and the power consumption E2 that is an allotment of the power consumption of the transport train 5 to the product set 26, according to the above expressions (9), (10).

In S16, the control device 51 reads the first conversion formula from the storage device 52, and calculates the CO2 emissions Qm1 from the transportation of the product set 16 by the transport train 5 by substituting the power consumption E1 into the first conversion formula. The control device 51 also calculates the CO2 emissions Qm2 from the transportation of the product set 26 by the transport train 5 by substituting the power consumption E2 into the first conversion formula.

In S17, the control device 51 associates each of the CO2 emissions Qm1, Qm2 with a corresponding one of the delivery numbers, and stores the CO2 emissions Qm1, Qm2 in association with the delivery numbers in the storage device 52. More specifically, the control device 51 stores the CO2 emissions Qm1 in association with the delivery number of the product set 16 in the storage device 52. The control device 51 also stores the CO2 emissions Qm2 in association with the delivery number of the product set 26 in the storage device 52.

As described above, in the case where the product set 16 and the product set 26 are unloaded from the transport train 5 at different stations, the management center 50 according to the second embodiment divides the transport section for transportation by the transport train 5 into the first section where the product set 16 and the product set 26 are consolidated and the second section where the product set 16 and the product set 26 are not consolidated. The management center 50 then proportionally divides, for each section, the power consumption (energy consumption) in the section based on the weight ratio between the consolidated products. Accordingly, even when the product set 16 and the product set 26 are unloaded from the transport train 5 at different stations, the CO2 emissions in each section can be appropriately calculated.

Although an example in which two sets (products), namely the product set 16 and the product set 26, are consolidated on the transport train 5 is described above, three or more sets may be consolidated on the transport train 5. For example, in the case where three sets are consolidated on the transport train 5, the transport section can be divided into a section where the three sets are consolidated, a section where two of the three sets are consolidated, and a section where one of the three sets is loaded. Alternatively, the transport section may be divided based on the stations at which the transport train 5 stops. For example, it is assumed that the transport train 5 transports products from an A station that is a departure station of the transport train 5 to a B station that is a destination station of the transport train 5, and the transport train 5 stops at a C station and a D station that are located between the A station and the B station. In this case, the transport section of the transport train 5 can be divided into the section from the A station to the C station, the section from the C station to the D station, and the section from the D station to the B station. Power consumption can be allotted to each product based on the weight ratio between or among the products loaded in each section.

It is also conceivable that the product set 16 is loaded onto one transport vehicle 9 at the factory 1 of the company A, the product set 26 is then loaded onto the transport vehicle 9 at the factory 2 of the company B, and the transport vehicle 9 transports the product set 16 and the product set 26 to the A station 6. In this case, the transport section of the transport vehicle 9 can also be divided into the section from the factory 1 to the factory 2 and the section from the factory 2 to the A station 6, and the fuel consumption can be proportionally divided based on the weight ratio. CO2 emissions from the transportation by the transport vehicle 9 can thus be appropriately proportionally divided.

The embodiments disclosed herein should be construed as illustrative in all respects, and not restrictive. The scope of the present disclosure is shown by the scope of claims rather than the above description, and is intended to include all modifications within the meaning and scope equivalent to the scope of claims.

What is claimed is:

1. A management device that manages a moving object that transports as a consolidated load a plurality of products including a first product and a second product, the management device comprising:
a storage device that stores an amount of energy consumed by the moving object in a transport section; and
a control device that calculates CO2 emissions of the first product from the transportation and CO2 emissions of the second product from the transportation, based on the amount of energy and a weight ratio between the first and second products loaded on the moving object.

2. The management device according to claim 1, wherein the control device proportionally divides the amount of energy between the first product and the second product based on the weight ratio to calculate the CO2 emissions of the first product from the transportation and the CO2 emissions of the second product from the transportation.

3. The management device according to claim 2, wherein
the transport section includes a first section where the first product and the second product are consolidated, and a second section where the first product is loaded and the second product is not loaded, and
the control device proportionally divides an amount of energy consumed by the moving object in the first section between the first product and the second product based on the weight ratio between the first and second products, and proportionally divides an amount of energy consumed by the moving object in the second section to the first product.

4. The management device according to claim 2, wherein
the storage device stores conversion information for converting an amount of energy to CO2 emissions, and
the control device uses the conversion information to convert the amount of energy proportionally divided to the first product to the CO2 emissions of the first product from the transportation and convert the amount of energy proportionally divided to the second product to the CO2 emissions of the second product from the transportation.

5. A management method for managing a moving object that transports as a consolidated load a plurality of products including a first product and a second product, the management method comprising:
reading an amount of energy consumed by the moving object in a transport section; and
calculating CO2 emissions of the first product from the transportation and CO2 emissions of the second product from the transportation, based on the amount of energy and a weight ratio between the first and second products loaded on the moving object.
